(19) United States
(12) Patent Application Publication
(10) Pub. No.: US 2024/0222894 A1
(43) Pub. Date: Jul. 4, 2024

(54) CONNECTOR

(71) Applicant: Taicang Manaflex Technology Co., Ltd., Taicang City (CN)

(72) Inventors: Robert C. Lane, Las Vegas, NV (US); Augusto E. Barton, Pinecrest, FL (US); Yifei Liu, Toronto (CA)

(21) Appl. No.: 18/397,132

(22) Filed: Dec. 27, 2023

(30) Foreign Application Priority Data
Dec. 28, 2022 (CN) 202211715119.8

(51) Int. Cl. H01R 12/79; H01R 13/03; H01R 13/15; H01R 13/639

(52) U.S. Cl. CPC H01R 12/79; H01R 13/03; H01R 13/15; H01R 13/639

(57) ABSTRACT

A connector comprising a first circuit board and a second circuit board disassembled on the first circuit board through a connecting piece, the connecting piece slides through the first circuit board and the second circuit board, and the first circuit board and the second circuit board are fixed to each other, the first circuit board is provided with a conductive part, the second circuit board is provided with a contact part, and the second circuit board is provided with a contact part. When the second circuit board is installed on the first line circuit board, the conductive part and the contact part are electrically connected. The connector of the invention is simple in structure and convenient for disassembly and assembly between the first line circuit board and the second circuit board.

### CROSS REFERENCE TO RELATED APPLICATION

This application claims the benefit of and priority under 35 U.S.C. § 119 to Chinese Utility Model Application No. 202211715119.8 filed on Dec. 28, 2022, the entire contents of which are hereby incorporated by reference for all purposes.

### TECHNICAL FIELD

The invention relates to the technical field of electrical connectors, in particular to a connector.

### BACKGROUND

Connectors for electrical connections between electronic components such as two circuit boards to achieve current and/or signal transmission functions. Connectors and circuit boards are connected by plugging or welding. Among them, the plug-in connector needs to correspond to the circuit board one by one, the compatibility between the different types of connectors and electronic components is poor, and the replacement cycle of electronic components is short. The damage of a single electronic component may lead to the need to replace the components of the entire electrical circuit, resulting in increased costs and waste, and welded connector, fixed connection cannot be disassembled, the same is not conducive to the subsequent disassembly and replacement of electronic components.

### SUMMARY

The object of the invention is to provide a connector to overcome a deficiency in the prior technology.

To realize the above purpose, the invention provides the following technical scheme:

The implementation of the invention discloses a connector, which comprises a first circuit board and a second circuit board disassembled in the first circuit board through a connecting piece, the connecting piece slides through the first circuit board and the second circuit board, and the first circuit board and the second circuit board are fixed to each other, the first circuit board is provided with a conductive part, the second circuit board is provided with a contact part, and the second circuit board is provided with a contact part. When the second circuit board is installed on the first line circuit board, the conductive part and the contact part are electrically connected.

Further, in the connector, the first line circuit board is a hard circuit board, and is provided with the first mounting hole corresponding to the connecting piece.

Further, in the connector, the second circuit board is a soft circuit board, and is provided with a second mounting hole corresponding to the connector, the second circuit board includes a number of conductive lines and laminates on both sides of the conductive line protective film, close to the first line of the protective film processing has a conductive line corresponding avoidance hole. The conductive circuit exposed in the avoidance hole forms the contact part.

Further, in the connector, the surface of the conductive part is provided with a gold plating layer, and a contact spring sheet for conducting the conductive part and the contact part is welded.

Further, in the connector, the first line road plate and the second circuit board are provided with a limit sleeve that limits the pressing depth of the contact spring sheet, and the connecting piece slides through the limit sleeve.

Further, in the connector, the contact spring is made of stainless steel, and the surface is nickel-plated, and the position where the contact spring is in contact with the contact part is provided with a gold-plated layer.

Further, in the connector, the conductive lines are metallic copper material, and the gold plating of the contact spring is connected to the corresponding contact part.

Further, in the connector, the contact spring is metal copper material, the conductive line is metal aluminum material, and the contact part near the first line of the road plate is fixed on the side of the connecting aluminum plate is arranged near the side of the contact spring plate nickel-plated layer, the contact spring plate of the gold plated layer against the corresponding connection aluminum plate nickel-plated layer.

Further, in the connector, the first line between the road plate and the second circuit board is provided with a gasket, the gasket is provided with a conductive window, the conductive part and the contact part are set in the scope of the conductive window.

Further, in the connector, the sealing gasket is provided with an avoidance slot corresponding to the limit sleeve.

Further, in the connector, the thickness of the limit sleeve is less than the thickness of the sealing gasket.

Further, in the said connector, the gasket is made of a high temperature resistant insulating material.

Further, in the said connector, the number of the connecting pieces is at least two groups.

Further, in the connector, a reinforcing aluminum sheet is arranged between the two protective films along the outer side of the second mounting hole, and the connecting piece slides through the reinforcing aluminum sheet.

Further, in the connector, the reinforced aluminum sheet is extended within the protective film and is arranged at an interval with the conductive line.

Further, in the connector, one side of the second circuit board deviating from the first line circuit board is provided with an insulating protection board.

Further, in the connector, an adhesive layer is arranged between the insulation protection board and the second circuit board.

Further, in the connector, the insulation protection board is provided with a third mounting hole corresponding to the connector, and the opening at both ends of the third mounting hole is respectively provided with a guide cone.

Compared with the prior technology, the invention has the advantages that the connector has simple structure, and the first line road board and the second circuit board can be disassembled and connected through the connecting piece, which is convenient for disassembly and replacement.

### BRIEF DESCRIPTION OF THE DRAWINGS

In order to more clearly explain the technical scheme in the implementation of the invention or the prior technology, the following is a brief introduction of the drawings required to be used in the description of the implementation or the prior technology. It is obvious that the drawings in the description below are only some implementations recorded in the invention. For ordinary technicians in the field, without creative labor, other drawings can also be obtained according to these drawings.

FIG. 1 shows a structural diagram of a connector in a specific implementation of the invention.

FIG. 2 shows the installation schematic diagram of the second circuit board after omitting the protective film in a specific implementation of the invention.

FIG. 3 shows the structural diagram of the first circuit board in a specific implementation of the invention.

FIG. 4 shows the structural diagram of the second circuit board in a specific implementation of the invention.

FIG. 5 shows a processing diagram of a connecting aluminum sheet in a specific implementation of the invention.

FIG. 6 shows the structural diagram of the gasket in a specific implementation of the invention.

FIG. 7 shows the structural diagram of the upper insulation protection board in a specific implementation of the invention.

### DETAILED DESCRIPTION

The following is a detailed description of the technical scheme in the implementation of the invention in combination with the drawings attached to the implementation of the invention. Obviously, the described implementation is only a part of the implementation of the invention, but not the whole implementation. Based on the implementations of the invention, all other implementations obtained by ordinary technicians in the field without making creative labor fall within the scope of protection of the invention.

In the description of the invention, it should be noted that the orientation or position relationships indicated by the terms “center,” “up,” “down,” “left,” “right,” “vertical,” “horizontal,” “inside,” “outside,” etc., are based on the orientation or position relationships shown in the attached drawings only for the purpose of facilitating the description of the invention and simplifying the description. Rather than indicating or implying that the device or element referred to must have a particular orientation, be constructed and operated in a particular orientation, and therefore cannot be understood as a limitation of the present invention. Furthermore, the terms “first,” “second,” and “third” are used only for descriptive purposes and are not to be understood as indicating or suggesting relative importance.

In the description of the present invention, it should be noted that, unless otherwise expressly specified and qualified, the terms “mounting,” “connecting” and “coupling” shall be understood in a broad sense, for example, they may be fixed connections, removable connections, or connected in one, it may be a mechanical connection or an electrical connection, it can be directly connected, or indirectly connected through an intermediate medium, and it can be the connection within the two components. For persons of ordinary skill in the art, the specific meaning of the above terms in the present invention can be understood on a case-by-case basis.

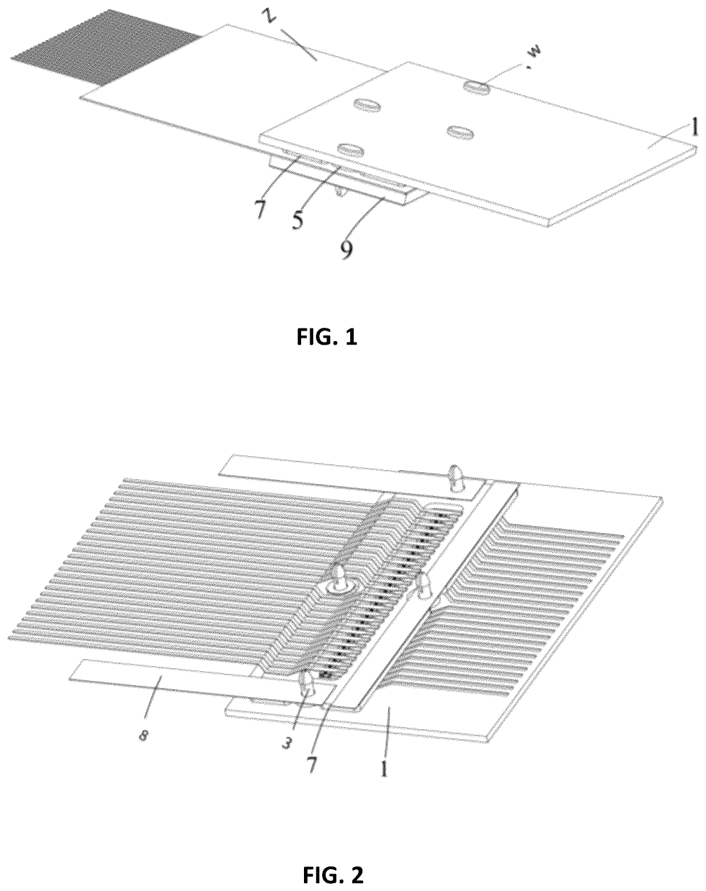

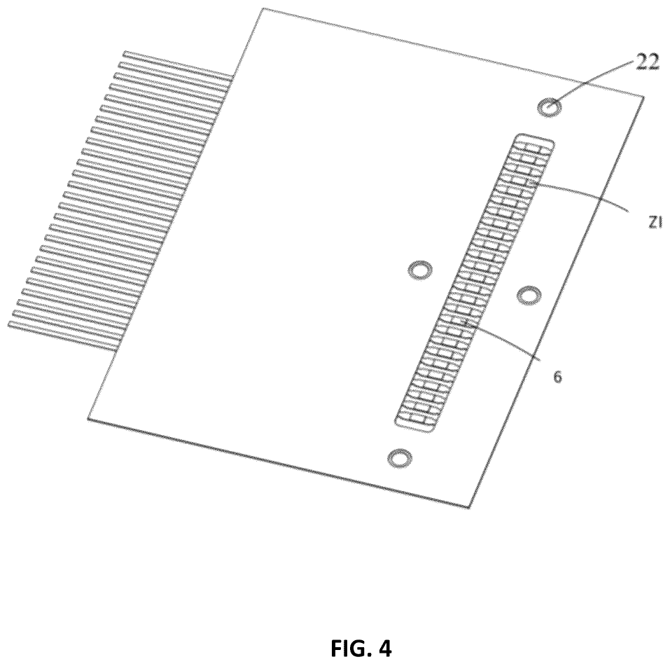

Referring to FIG. 1 to FIG. 4, a connector comprises a first circuit board 1, a second circuit board 2, and a connector 3 sliding through the first circuit board 1 and the second circuit board 2. A detachable connection is realized between the first circuit board 1 and the second circuit board 2 through a connector, wherein the connector can be a latch, a rivet or a screw, etc. A conductive part 11 is arranged in the first circuit board 1. A contact part 21 is arranged in the second circuit board 2, and when the second circuit board 2 is installed in the first line circuit board 1, the conductive part 11 and the contact part 21 are electrically connected.

In the technical scheme, the conductive part and the contact part are preset in the corresponding position during the manufacturing process of the first line circuit board and the second circuit board, the conductive part and the contact part are connected to the corresponding electronic components through the printed circuit built in the first line circuit board and the second circuit board, and the conductive part and the contact part are electrically connected after the second circuit board is fixed in the first line circuit board to achieve the corresponding circuit connection, convenient disassembly.

In the example shown in FIG. 1 to FIG. 4, the first line circuit board 1 is a hard circuit board, and is provided with the first mounting hole 12 corresponding to connector 3.

In the technical scheme, the first line of the circuit board for the printed circuit board (PCB circuit board, English printed circuit board for short), its surface is set as a conductive part of the use of copper pad, and preconfigured with the first mounting hole, the first mounting hole and the first line of the circuit in the plate staggered settings, among which, the number of solder pads is a single or multiple combination settings.

For example, as shown in FIG. 1 to FIG. 4, the second circuit board 2 is a soft circuit board, and is provided with a second installation hole 22 corresponding to connector 3. The second circuit board 2 comprises a number of conductive circuits and a protective film laminated on both sides of the conductive circuit, and the protective film near the first line board side is processed with a conductive circuit corresponding avoidance hole. The conductive circuit exposed in the avoidance hole forms the contact part 21.

In the technical scheme, the second circuit board is a flexible circuit board (FPC circuit board, English Flexible Printed Circuit for short), conductive circuit and protective film cutting and punching and other processing is completed, in the form of protective film—conductive circuit—protective film stacked and laminated into flexible circuit board, and the second installation hole and the avoidance hole are processed before lamination. The conductive circuit part within the range of the avoidance hole is used as the contact part, which is used for electrical connection with the conductive part.

For example, as shown in FIG. 3, the surface of the conductive part 11 is provided with a gold deposit layer and a contact spring plate 4 for conducting the conductive part and the contact part is welded.

In the technical scheme, the surface of the conductive part is provided with a gold settling layer through the existing gold settling process. The gold has strong conductivity, good oxidation resistance, and is easier to weld. The contact spring sheet (also known as spring finger contact, shielding finger, grounding spring, universal grounding contact or clamp) can be directly selected with the structure recorded in the prior technology, which has a certain elastic shape variable. Improve the stability of the electrical connection between the conductive part and the contact part.

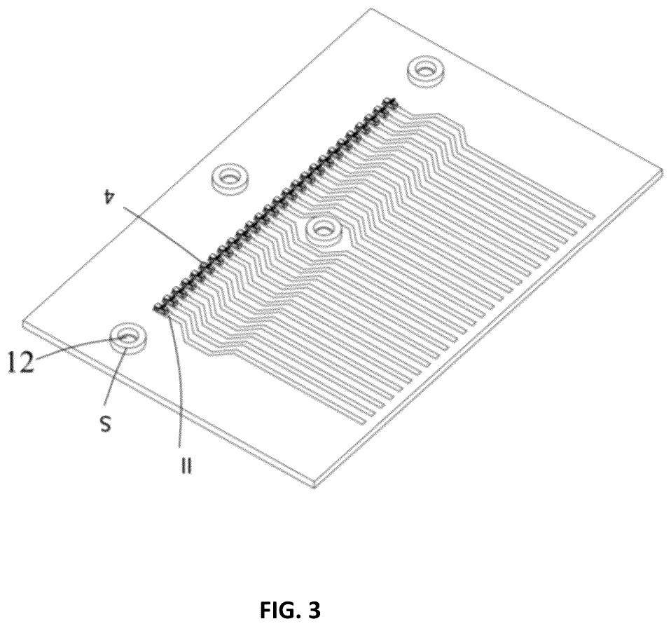

Illustratively, as shown in FIGS. 2 and 3, the first line circuit board 1 and the second circuit board 2 are provided with a limit sleeve 5 that limits the pressing depth of the contact spring plate 4, and the connector slides through the limit sleeve 5.

In the technical scheme, the limit sleeve is a ring structure, which is fixed on the first line road plate through the process of mounting, or placed freely, and is set on the connecting piece during the assembly process. The first line road plate and the second circuit board are respectively fitted to the two end faces of the limit sleeve, and the installation position of the second circuit board is limited by the thickness of the limit sleeve, so as to avoid the damage caused by excessive extrusion of the contact part.

As an example, the contact spring plate 4 is made of stainless steel and is nickel-plated on the surface. The position where the contact spring plate contacts the contact part is provided with a gold coating (not shown).

In the technical scheme, the contact position between the contact spring and the contact part is gold-plated to form a gold-plated layer and improve the electrical conductivity.

For example, the conductive lines are made of metallic copper material, and the contact spring sheet 4 is connected to the corresponding contact part 21.

In the technical scheme, the conductive circuit is directly formed in the process of the second circuit board making board, and then the contact spring is installed on the corresponding conductive part one by one. When the second circuit board is fixed in the first line of the circuit board, the contact part is connected to the gold plating of the corresponding contact spring, to achieve electrical connection between the contact part and the conductive part, and squeeze the contact spring piece to improve the stability of the connection.

For example, as shown in FIG. 2 to FIG. 5, the contact spring plate 4 is made of metal copper, the conductive line is made of metal, and the side of the contact part 21 near the first line plate is fixed with connecting aluminum plate 6, the side of connecting aluminum plate 6 near the contact spring plate 4 is provided with nickel plating layer (not shown), and the gold-plated layer of the contact spring plate 4 is connected to the corresponding nickel plating layer.

In the technical scheme, the second circuit board is an aluminum-based FPC circuit board, and the conductive circuit is cut by aluminum foil. Among them, the surface of the metal aluminum is easy to form an oxide layer, and the high resistance of the oxide layer affects the conduction between the contact part and the contact spring piece, that is, the conduction between the contact part and the conductive part, so the side of the contact part near the first line of the road plate is welded with nickel-plated connecting aluminum sheet. The nickel plating layer of the contact aluminum sheet is close to the contact spring sheet, and the gold plating layer of the contact spring sheet is connected to the corresponding nickel plating layer, so as to realize the electrical connection between the contact part and the conductive part, and squeeze the contact spring sheet to improve the stability of the connection.

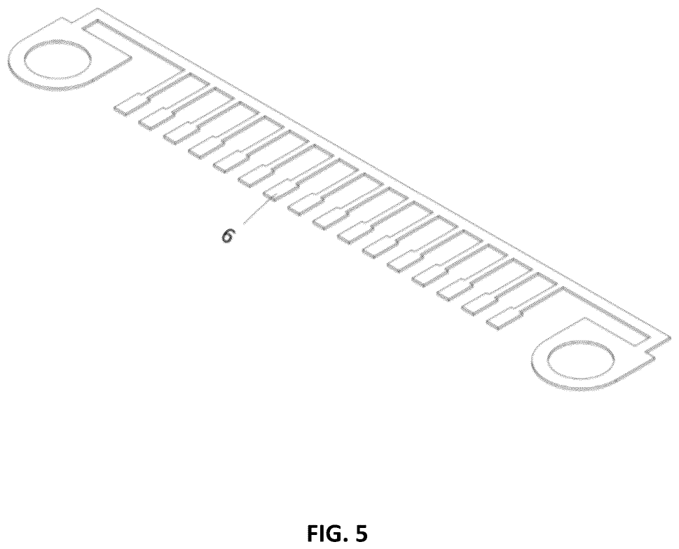

As shown in FIG. 5, in the actual production process of connecting aluminum sheets, nickel-plated aluminum sheets are directly selected and then cut into a comb structure, that is, multiple connecting aluminum sheets are connected to the same connection strip, both ends of the connection strip are provided with positioning sheets for welding, positioning holes are processed in the positioning sheet, and before welding, the positioning holes and the second mounting holes are simultaneously set behind the positioning pin. All the connected aluminum sheet and the corresponding contact parts correspond one by one, and then through laser welding the connected aluminum sheet is welded to the end of the aluminum-based FPC circuit board, and after the completion of welding, the excess connection bar can be partially cut off, and the positioning of all the connected aluminum sheet can be completed at one time to improve production efficiency.

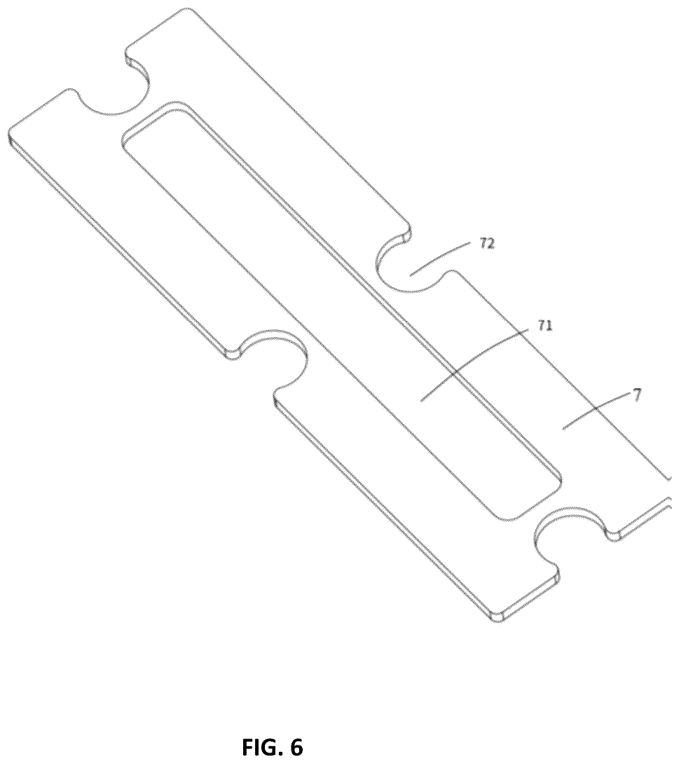

For example, as shown in FIG. 6, a gasket 7 is arranged between the first line circuit board 1 and the second circuit board 2, a conductive window 71 is arranged in the gasket 7, and the contact spring sheet 4 and the contact part 21 are arranged in the range of the conductive window 71.

In the technical scheme, the sealing gasket is made of soft silicon foam material and other high temperature/flame retardant materials, and has good waterproof performance. The conductive part between the first line circuit board and the second circuit board is sealed in the conductive window to avoid short circuit caused by debris and water vapor contact with the conductive part, so as to improve the safety and stability of use.

For example, as shown in FIG. 6, the sealing gasket 7 is provided with an avoidance slot 72 corresponding to the limit sleeve.

In the technical scheme, the sealing gasket avoids the position of the limit sleeve by setting a limit slot, so as to avoid the first line circuit plate and the second circuit board caused by the overlap of the sealing gasket and the limit sleeve.

For example, the thickness of the limit sleeve 5 is less than the thickness of the sealing gasket 7.

In the technical scheme, the side of the second circuit board and the first line board are fitted to the corresponding side of the gasket, and the installation position of the second circuit board is limited by the thickness of the limit sleeve to avoid the damage caused by excessive extrusion of the contact part and the spring sheet. The thickness of the limit sleeve is consistent with the height of the spring contact sheet after compression, that is, the gasket is pressed thin in the layer of the second circuit board installation. The thickness of the gasket after being pressed thin is consistent with the height of the convex and compressed spring contact sheet.

The gasket 7 is, by example, made of insulating material that is resistant to high temperatures.

In the technical scheme, when the circuit is connected, it will inevitably heat up, and the sealing gasket is made of high temperature resistant insulation material to improve the safety of use.

For example, as shown in FIG. 1 to FIG. 4, the number of connecting parts is at least two groups.

In the technical scheme, a simple rivet is arranged around the conductive window as a connecting piece, and the lines in the first line circuit board and the second circuit board all bypass the corresponding positions of the first installation hole and the second installation hole. When the connecting piece is two, there will be a small gap swing between the first line and the second circuit board (the connecting piece and the first mounting hole and the second mounting hole gap), which may lead to damage to the spring contact piece, etc., the connecting piece is set up three or four, and is not in the same straight line, which can reduce or eliminate the above swing.

For example, as shown in FIG. 2, a reinforcing aluminum sheet 8 is arranged between the two protective films along the outside of the second mounting hole, and the connector slides through the reinforcing aluminum sheet 8.

In the technical scheme, the reinforced aluminum sheet is processed with a coaxial through hole with the second mounting hole. The protective film is made of polyimide or polyester film, which is soft in texture and easy to be deformed by force. The deformation at the second mounting hole is avoided by setting the reinforced aluminum sheet.

Exemplified, as shown in FIG. 2, the reinforced aluminum sheet is extended in the protective film and is set at an interval with the conductive line.

In the technical scheme, the reinforced aluminum sheet located between the conductive line is a ring structure and cannot be extended, while the rest of the reinforced aluminum sheet is a long strip structure and extends along the length direction of the conductive line or perpendicular to the length direction of the conductive line to increase the contact area between it and the protective film and improve the fixed reliability between the protective film.

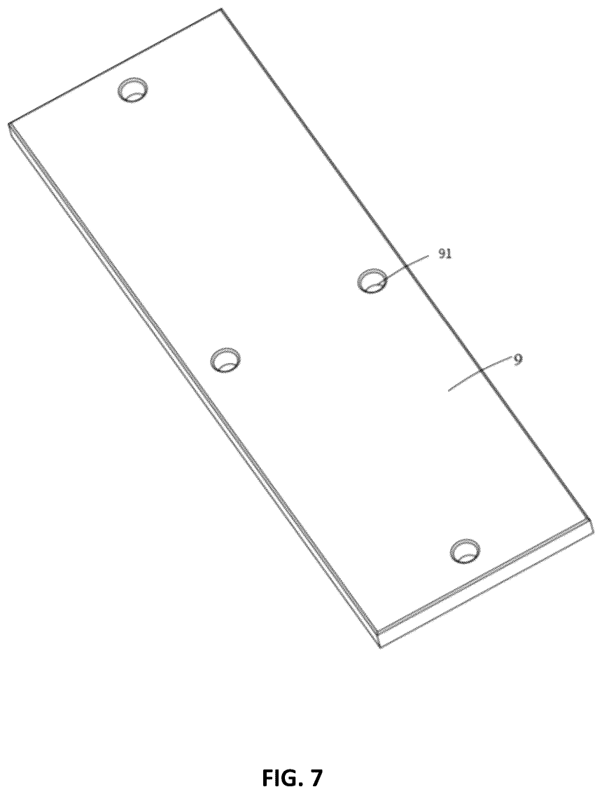

For example, as shown in FIG. 1 and FIG. 7, the side of the second circuit board 2 deviating from the first line circuit board 1 is provided with an insulating protection board 9.

In actual production, the insulation protection board made of FR4 resin is covered on the surface of the second circuit board to avoid the deformation caused by the contact part being squeezed by the contact spring sheet for a long time, and to prevent the leakage caused by the damage of the protective film at the contact part. At the same time, the insulation protection board can also strengthen the overall strength of the connector.

For example, an adhesive layer (not shown) is arranged between the insulating protection board 9 and the second circuit board 2.

In the technical scheme, double-sided tape is directly pasted on the corresponding position on the surface of the second circuit board, and then the insulation protection board is fixed on the surface of the second circuit board, and the gap between the insulation protection board and the second circuit board is eliminated through the setting of the adhesive layer, and the overall scaling performance of the connector is improved.

For example, as shown in FIG. 7, the insulation protection board 9 is provided with a third installation hole 91 corresponding to the connector, and the two ends of the third installation hole are respectively provided with a guide cone.

In the technical scheme, the tip of the simple rivet as a connector runs through the first line road plate, connecting sleeve, second circuit board and insulation protection board in turn, and the guide cone is arranged to facilitate the connection piece to quickly align with the third mounting hole. After the installation of the connector, its head is fitted to the first line road plate, and the projection of its tip is stuck at one end of the third mounting hole. The first line of the road plate and the second circuit board is fixed between the need to open maintenance or replacement, kneading the opening of the tip of the connector can be extracted, the first line of the road plate and the second circuit board can be separated.

To sum up, the connector is simple in structure, the first line circuit board and the second circuit board through the connector can be disassembled and connected, easy to disassemble and replace, and the overall sealing performance of the connector is excellent, improve the safety of use, but also suitable for aluminum circuit board, expand the scope of use.

It should be noted that, in this context, the term “includes,” “contains” or any other variation thereof is intended to cover non-exclusive inclusion so that a process, method, article or device comprising a series of elements includes not only those elements but also other elements not expressly listed, or elements inherent to such a process, method, article or equipment. Without any further limitation, the statement “includes a . . . ” does not preclude the existence of another identical element in the process, method, article or apparatus in which the element is included.

1. A connector, comprising:
a connecting piece;
a first line circuit board; and
a second circuit board assembled to the first line circuit board through the connecting piece, the connecting piece slides through the first line circuit board and the second circuit board, and the first line circuit board and the second circuit board are fixed to each other, wherein the first line circuit board is provided with a conductive part, the second circuit board is provided with a contact part, and when the second circuit board is installed on the first line circuit board, the conductive part and the contact part are electrically connected.

2. The connector of claim 1, wherein the first line circuit board is a hard circuit board and is provided with a first mounting hole corresponding to the connecting piece.

3. The connector of claim 1, wherein the second circuit board is a soft circuit board, and is provided with a second mounting hole, the second circuit board comprises a number of conductive lines and laminates on both sides of a protective film, close to a first side of the protective film corresponding to an avoidance hole, and a conductive circuit exposed in the avoidance hole forms the contact part.

4. The connector of claim 3, wherein a surface of the conductive part is provided with a gold layer, and is welded for conducting the conductive part and a contact part of a contact spring sheet.

5. The connector of claim 4, wherein the first line circuit board and the second circuit board are provided with a limit sleeve that limits a depth of the contact spring sheet, and the connecting piece slides through the limit sleeve.

6. The connector of claim 4, wherein the contact spring sheet is made of stainless steel, and the surface of the contact spring sheet is nickel-plated, and the contact spring sheet is provided with a gold-plated layer at a position where the contact part contacts the contact spring sheet.

7. The connector of claim 6, wherein a conductive line of the second circuit board is made of metal copper material, and the gold-plated layer of the contact spring sheet is connected to the contact part.

8. The connector of claim 7, wherein the contact spring sheet is metal copper material, the conductive line is metal aluminum material, and the contact part near the first line circuit board is fixed on a side of an aluminum sheet, the aluminum sheet near the contact spring sheet is arranged on a side of a nickel plating layer, the contact spring sheet of a gold plated layer is against the nickel plating layer.

9. The connector of claim 5, wherein a gasket is arranged between the first line circuit board and the second circuit board, the gasket is provided with a conductive window, the conductive part and the contact part are set in a range of the conductive window.

10. The connector of claim 9, wherein the gasket is provided with an avoidance slot corresponding to the limit sleeve.

11. The connector of claim 9, wherein a thickness of the limit sleeve is less than a thickness of the gasket.

12. The connector of claim 9, wherein the gasket is made of high-temperature insulating material.

13. The connector of claim 1, wherein a quantity of connecting parts is at least two groups.

14. The connector of claim 3, wherein a reinforced aluminum sheet is arranged between two protective films along an outside of the second mounting hole, and the connecting piece slides through the reinforced aluminum sheet.

15. The connector of claim 14, wherein the reinforced aluminum sheet is extended in the protective film and is set at an interval with a conductive line.

16. The connector of claim 1, wherein one side of the second circuit board deviating from the first line circuit board is provided with an insulating protection board.

17. The connector of claim 16, wherein an adhesive layer is located between the insulating protection board and the second circuit board.

18. The connector of claim 16, wherein the insulating protection board is provided with a third mounting hole corresponding to the connecting piece, and an opening at both ends of the third mounting hole is provided with a guide cone.
